(19) United States
(12) Patent Application Publication
(10) Pub. No.: US 2026/0350005 A1
(43) Pub. Date: Nov. 5, 2026

(54) MATERIALIZED VIEW REBUILDS FOR OBJECT TABLE FORMAT STORED DATA

(71) Applicant: Teradata US, Inc., San Diego, CA (US)

(72) Inventors: Louis Martin Burger, Escondido, CA (US); Frank Roderick Vandervort, Ramona, CA (US)

(73) Assignee: Teradata US, Inc., San Diego, CA (US)

(21) Appl. No.: 19/195,686

(22) Filed: Apr. 30, 2025

(51) Int. Cl. G06F 16/2453

(52) U.S. Cl. CPC G06F 16/24539; G06F 16/24542

(57) ABSTRACT

A system may include a storage device and a plurality of processors in communication with the storage device. At least one of the plurality of processors may collect query telemetry associated with queries executed Open Table Format storage data and may predict at least one query to be received based on at least a portion of the collected query telemetry and may identify a materialized view (“MV”) in the collected query telemetry associated with the at least one predicted query. The at least one of the plurality of processors may determine if the identified MV is to be rebuilt based on at least one condition and may rebuild the MV to be used during execution of the predicted query. The at least one of the plurality of processors may execute the predicted query upon receipt of the predicted query. A method and computer readable-medium are also disclosed.

### BACKGROUND

Materialized Views (“MVs”) have been a cornerstone of SQL database engines, providing significant performance enhancements by persisting precomputed results and enabling automatic query rewriting, for example. These views are particularly beneficial for workloads that frequently access common intermediate results. However, a persistent challenge with MVs is maintaining their freshness as updates occur in the underlying base tables. Traditional methods for MV maintenance often rely on proprietary file systems and exclusive engine ownership, which are not feasible in modern cloud environments that support Open Table Format (“OTF”).

OTF is an open-source, standard table format that allows multiple engines or tools, potentially from different vendors, to work on the same data in a transactionally consistent manner. This presents unique challenges for MV maintenance, as updates can be performed by different engines, making it difficult to synchronize MVs with their underlying base tables. The absence of traditional database indexes in OTF further complicates this issue, necessitating the use of expensive offline rebuild operations to keep MVs refreshed.

The problem is exacerbated by the fact that relying on manual or fixed-schedule MV rebuilds often results in suboptimal system performance. The optimal rebuild rate can vary for each MV, involving a complex trade-off between the overhead cost of rebuilding and the negative performance impact on near-term queries that would otherwise benefit from the MVs. Additionally, some queries may have defined service level goals (“SLGs”) that require the use of MVs to achieve them, increasing the urgency of timely MV maintenance.

Thus, it would be desirable to determine MVs appropriate for rebuilds on data stored in OTF.

### SUMMARY

According to one aspect of the disclosure, a system may include a storage device. The system may further include a plurality of processors in communication with the storage device. The at least one of the plurality of processors may collect query telemetry associated with queries executed on data stored in Open Table Format (“OTF”) storage. The at least one of the plurality of processors may predict at least one query to be received based on at least a portion of the collected query telemetry. The at least one of the plurality of processors may identify a materialized view (“MV”) in the collected query telemetry associated with the at least one predicted query. The at least one of the plurality of processors may determine if the identified MV is to be rebuilt based on at least one condition. The at least one of the plurality of processors may, in response to presence of the at least one condition, rebuild the MV to be used during execution of the predicted query. The at least one of the plurality of processors may execute the predicted query upon receipt of the predicted query.

According to another aspect of the disclosure, a method may include collecting, with a processor, query telemetry associated with queries executed on data stored in OTF storage. The method may include predicting, with the processor, at least one query to be received based on at least a portion of the collected query telemetry. The method may include identifying, with the processor, a materialized view (“MV”) in the collected query telemetry associated with the at least one predicted query. The method may include determining, with the processor, if the identified MV is to be rebuilt based on at least one condition. The method may include, in response to presence of the at least one condition, rebuilding, with the processor, the MV to be used during execution of the predicted query. The method may include executing, with the processor, the predicted query upon receipt of the predicted query.

According to another aspect of the disclosure, a non-transitory computer-readable medium may be encoded with a plurality of instructions executable by a processor. The plurality of instructions may include instructions to collect query telemetry associated with queries executed on data stored in Open Table Format storage. The plurality of instructions may include instructions to predict at least one query to be received based on at least a portion of the collected query telemetry. The plurality of instructions may include instructions to identify a materialized view (“MV”) in the collected query telemetry associated with the at least one predicted query. The plurality of instructions may include instructions to determine if the identified MV is to be rebuilt based on at least one condition. The plurality of instructions may include in response to presence of the at least one condition, instructions to rebuild the MV to be used during execution of the predicted query. The plurality of instructions may include executing, with the processor, the predicted query upon receipt of the predicted query.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of an example analytic environment.

FIG. 2 is a detailed block diagram of a processing node.

FIG. 3 is a detailed block diagram of an optimizer module.

FIG. 4 is a detailed block diagram of a parser module

FIG. 5 is a block diagram of an example Open Table Format storage system interacting with a database management system.

FIG. 6 is a block diagram of an example local engine ecosystem.

FIG. 7 is a block diagram of example operation of a workload forecaster model.

FIG. 8 is a block diagram an example of training and using a workload forecaster model.

FIG. 9 is an example of a materialized view rebuild schedule.

FIG. 10 is an example of an extension of a threshold algorithm used by the local engine ecosystem.

FIG. 11 is an example of adjustment strategies of a materialized view rebuild schedule.

FIG. 12 is an operational flow diagram of example operation of a local engine ecosystem.

### DETAILED DESCRIPTION OF THE FIGURES

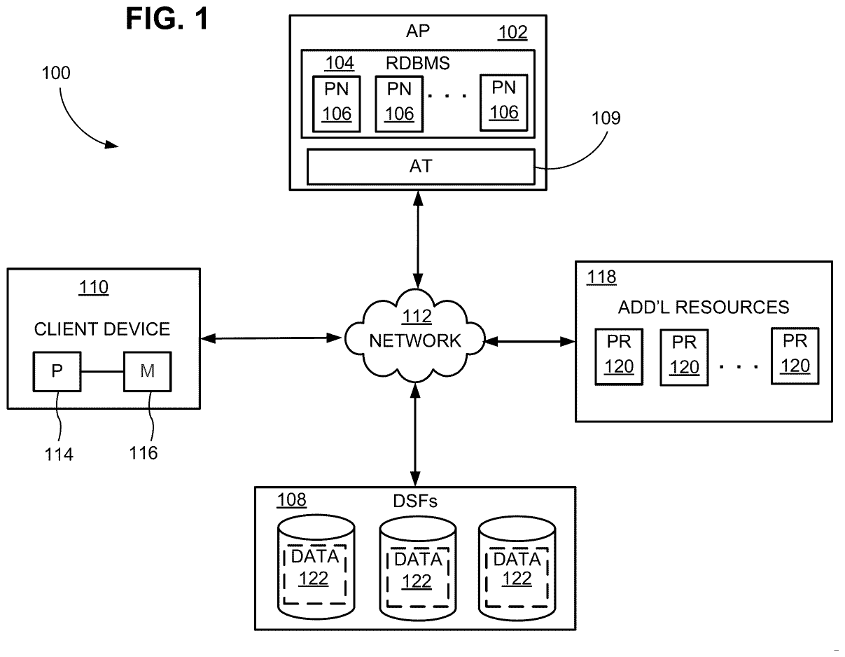

FIG. 1 is a block diagram of an example analytic environment 100. In one example, the analytic environment 100 may include an analytic platform (“AP”) 102, such as Teradata Vantage. The analytic platform 102 may include one or more systems that may be used independently or with one another in conducting advanced analytics. The analytic platform 102 may include a relational database management system (“RDBMS”) 104. In one example, the RDBMS 104 may implement a parallel-processing environment to conduct database management. The RDBMS 104 may be a combination of software (e.g., computer program routines, subroutines, applications, etc.) and hardware (e.g., processors, memory, etc.). In the example of FIG. 1, the RDBMS 104 may be a massively parallel processing (MPP) system having a number of processing nodes 106. In alternative examples, the RDBMS 104 may implement a single processing node, such as in a symmetric multiprocessing (SMP) system configuration. The RDBMS 104 may include one or more processing nodes 106 used to manage the storage, retrieval, and manipulation of data in data storage facilities (DSFs) 108. The DSFs 108 may represent various types of storage, such as persistent and/or non-persistent, for example. The processing nodes 106 may manage the storage, retrieval, and manipulation of data included in a database.

The analytic environment 100 may include a client device 110 that communicates with the analytic platform 102 via a network 112. The client device 110 may represent one or more devices, such as a graphical user interface (“GUI”), that allows user input to be received. The client device 110 may include one or more processors 114 and memory(ies) 116. The network 112 may be wired, wireless, or some combination thereof. The network 112 may be a cloud-based environment, virtual private network, web-based, directly-connected, and/or some other suitable network configuration. In one example, the client device 110 may run a dynamic workload manager (DWM) client (not shown).

The analytic environment 100 may also include additional resources 118. Additional resources 118 may include processing resources (“PR”) 120. In a cloud-based network environment, the additional resources 118 may represent additional processing resources that allow the analytic platform 102 to expand and contract processing capabilities as needed.

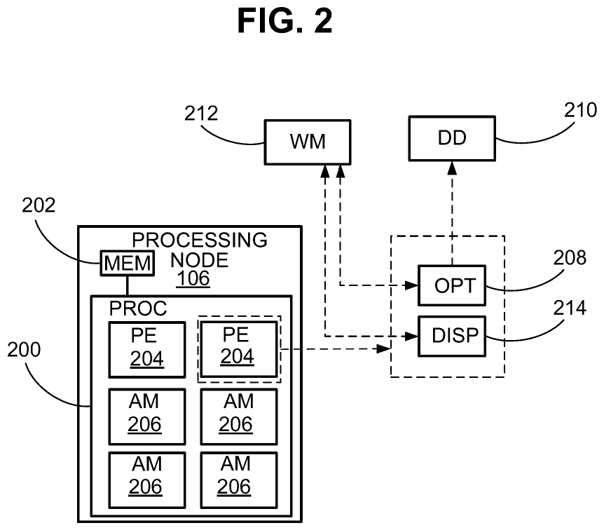

FIG. 2 is an example of a processing node 106, which may include one or more physical processors 200 and memory(ies) 202. Memory(ies) 202 may include one or more memories and may be computer-readable storage media or memories, such as a cache, buffer, random access memory (RAM), removable media, hard drive, flash drive or other computer-readable storage media. Computer-readable storage media may include various types of volatile and nonvolatile storage media. Various processing techniques may be implemented by the processors 200 such as multiprocessing, multitasking, parallel processing, and the like, for example.

The processing nodes 106 may include one or more other processing unit types such as parsing engine (PE) modules 204 and access modules (AM) 206. As described herein, each module, such as the parsing engine modules 204 and access modules 206, may be hardware or a combination of hardware and software. For example, each module may include an application specific integrated circuit (ASIC), a Field Programmable Gate Array (FPGA), a circuit, a digital logic circuit, an analog circuit, a combination of discrete circuits, gates, or any other type of hardware or combination thereof. Alternatively, or in addition, each module may include memory hardware, such as a portion of the memory 202, for example, which includes instructions executable with the processor 200 or other processor to implement one or more of the features of the module. When any one of the modules includes the portion of the memory 202 that comprises instructions executable with the processor, the module may or may not include the processor. In some examples, each module may just be the portion of the memory 202 or other physical memory that comprises instructions executable with the processor 200 or other processor to implement the features of the corresponding module without the module including any other hardware. Because each module includes at least some hardware even when the included hardware comprises software, each module may be interchangeably referred to as a hardware module, such as the parsing engine hardware module or the access hardware module. The access modules 206 may be access modules processors (AMPs), such as those implemented in the Teradata Vantage analytic platform, for example.

The parsing engine modules 204 and the access modules 206 may each be virtual processors (vprocs) and/or physical processors. In the case of virtual processors, the parsing engine modules 204 and access modules 206 may be executed by one or more physical processors, such as those that may be included in the processing nodes 106. For example, in FIGS. 1-2, each parsing engine module 204 and access module 206 is associated with a respective processing node 106 and may each be executed as one or more virtual processors by physical processors 200 included in the respective processing node 106.

In FIG. 2, each processing node 106 is shown as including multiple parsing engine modules 204 and access modules 206, such that there are more parsing engine modules 204 and access modules 206 than processing nodes 106. In one example, during operation, the one or more physical processors 200 included in the processing nodes 106 may execute the parsing engine modules 204 and access modules 206 by switching between the executions of the various modules at a rapid rate allowing the vprocs to substantially operate in “parallel.”

The RDBMS 104 stores data 122 in one or more tables (or other data object formats) in the DSFs 108. In one example, the data 122 may represent rows of stored tables that are distributed across the DSFs 108 and in accordance with their primary index. The primary index defines the columns of the rows that are used for calculating a hash value. The function that produces the hash value from the values in the columns specified by the primary index is called the hash function. Some portion, possibly the entirety, of the hash value is designated a “hash bucket.” The hash buckets are assigned to DSFs 108 and associated access modules 206 by a hash bucket map. The characteristics of the columns chosen for the primary index determine how evenly the rows are distributed.

Rows of each stored table may be stored across multiple DSFs 108. Each parsing engine module 204 may organize the storage of data and the distribution of table rows. The parsing engine modules 204 may also coordinate the retrieval of data from the DSFs 108 in response to queries received, such as those received from a client system 108 connected to the RDBMS 104 through connection with a network 112.

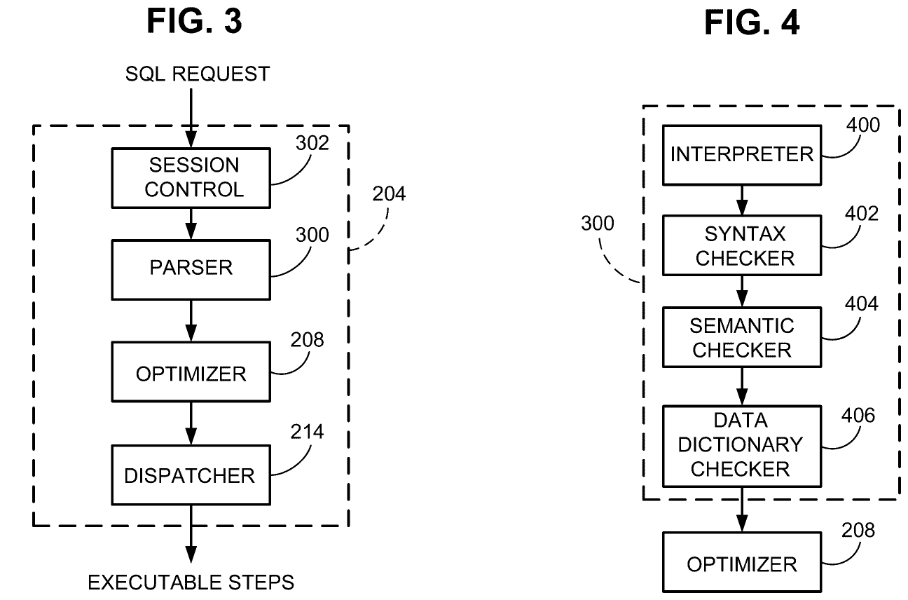

Each parsing engine module 204, upon receiving an incoming database query may apply an optimizer module 208 to assess the best plan for execution of the query. An example of an optimizer module 208 is shown in FIG. 2 with regard to a parsing engine module 204. Additional description of the parsing engine modules 204 is provided with regard to FIGS. 3 and 4. Selecting the optimal query-execution plan may include, among other things, identifying which of the processing nodes 106 are involved in executing the query and which database tables are involved in the query, as well as choosing which data-manipulation techniques will serve best in satisfying the conditions of the query. To this end, for each parsing engine module 204, a parser module 300 (see FIG. 3), and/or optimizer module 208 may access a data dictionary module 210, shown in FIG. 2 specifically for parsing engine module 204 for purposes of illustration.

The data dictionary module 210, which may reside in the RDBMS 104, may specify the organization, contents, and conventions of one or more databases, such as the names and descriptions of various tables maintained by the RDBMS 104 as well as fields/columns of each database, for example. Further, the data dictionary module 210 may specify the type, length, and/or other various characteristics of the stored tables. The RDBMS 104 typically receives queries in a standard format, such as the structured query language (SQL) put forth by the American National Standards Institute (ANSI). However, other languages and techniques, such as contextual query language (CQL), data mining extensions (DMX), and multidimensional expressions (MDX), graph queries, analytical queries, machine learning (ML), large language modes (LLM) and artificial intelligence (AI), for example, may be implemented in the RDBMS 104 separately or in conjunction with SQL. The data dictionary 210 may be stored in the DSFs 108 or some other storage device and selectively accessed.

The RDBMS 104 may include a workload management system workload management (WM) module 212, which may be executed within the RDBMS 104 by one or more processing nodes 106. The WM module 212 may be implemented as a “closed-loop” system management (CLSM) architecture capable of satisfying a set of workload-specific goals. In other words, the RDBMS 104 is a goal-oriented workload management system capable of supporting complex workloads and capable of self-adjusting to various types of workloads. The WM module 212 may communicate with each optimizer module 208, as shown in FIG. 2, and is adapted to convey a confidence threshold parameter and associated parameters to the optimizer module 208 in communication. Further, the WM module 212 may communicate with a dispatcher module 214 of each parsing engine module 206 (as shown in detail in FIG. 2 for parsing engine module 206) to receive query execution plan costs therefrom, and to facilitate query exception monitoring and automated modifications of confidence threshold parameters in accordance with disclosed embodiments.

The WM module 212 operation has four major phases: 1) assigning a set of incoming request characteristics to workload groups, assigning the workload groups to priority classes, and assigning goals (referred to as Service Level Goals or SLGs) to the workload groups; 2) monitoring the execution of the workload groups against their goals; 3) regulating (e.g. adjusting and managing) the workload flow and priorities to achieve the SLGs; and 4) correlating the results of the workload and taking action to improve performance. In accordance with disclosed embodiments, the WM module 212 is adapted to facilitate control of the optimizer module 208 pursuit of robustness with regard to workloads or queries.

An interconnection (not shown) allows communication to occur within and between each processing node 106. For example, implementation of the interconnection provides media within and between each processing node 106 allowing communication among the various processing units. Such communication among the processing units may include communication between parsing engine modules 204 associated with the same or different processing nodes 106, as well as communication between the parsing engine modules 204 and the access modules 206 associated with the same or different processing nodes 106. Through the interconnection, the access modules 206 may also communicate with one another within the same associated processing node 106 or other processing nodes 106.

The interconnection may be hardware, software, or some combination thereof. In instances of at least a partial-hardware implementation the interconnection, the hardware may exist separately from any hardware (e.g., processors, memory, physical wires, etc.) included in the processing nodes 106 or may use hardware common to the processing nodes 106. In instances of at least a partial-software implementation of the interconnection, the software may be stored and executed on one or more of the memories 202 and processors 200 of the processing nodes 106 or may be stored and executed on separate memories and processors that are in communication with the processing nodes 106. In one example, the interconnection may include multi-channel media such that if one channel ceases to properly function, another channel may be used. Additionally, or alternatively, more than one channel may also allow distributed communication to reduce the possibility of an undesired level of communication congestion among processing nodes 106.

In one example system, each parsing engine module 206 includes three primary components: a session control module 302, a parser module 300, and the dispatcher module 214 as shown in FIG. 3. The session control module 300 provides the logon and logoff functions. It accepts a request for authorization to access the database, verifies it, and then either allows or disallows the access. Once the session control module 302 allows a session to begin, a SQL request may be received such as through submission the client device 110 and the SQL request is routed to the parser module 300.

As illustrated in FIG. 4, the parser module 300 may include an interpreter module 400 that interprets the SQL request. The parser module 300 may also include a syntax checker module 402 that checks the request for correct SQL syntax, as well as a semantic checker module 404 that evaluates the request semantically. The parser module 302 may additionally include a data dictionary checker 406 to ensure that all of the objects specified in the SQL request exist and that the user has the authority to perform the request. The parsing engine module 206 implements the optimizer module 208 to select the least expensive plan to perform the request, and the dispatcher 214 coordinates the runtime execution of executable steps of the query execution plan of the optimizer module 208 with the access modules 206.

In one example, to facilitate implementations of automated adaptive query execution strategies, such as the examples described herein, the WM module 212 monitoring takes place by communicating with the dispatcher module 214 as it checks the query execution step responses from the access modules 206. The step responses include the actual cost information, which the dispatcher module 214 may then communicate to the WM module 212 which, in turn, compares the actual cost information with the estimated costs of the optimizer module 208.

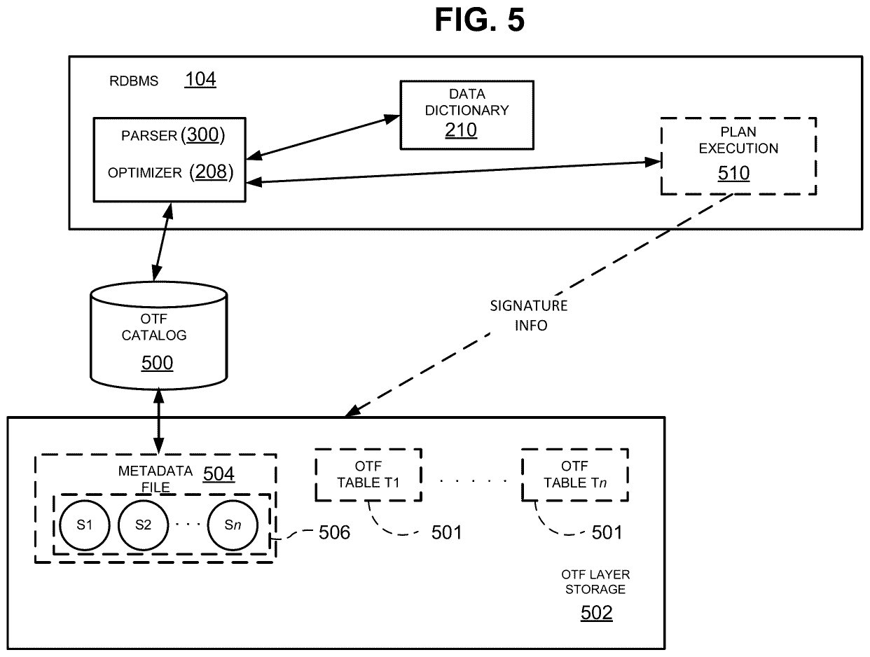

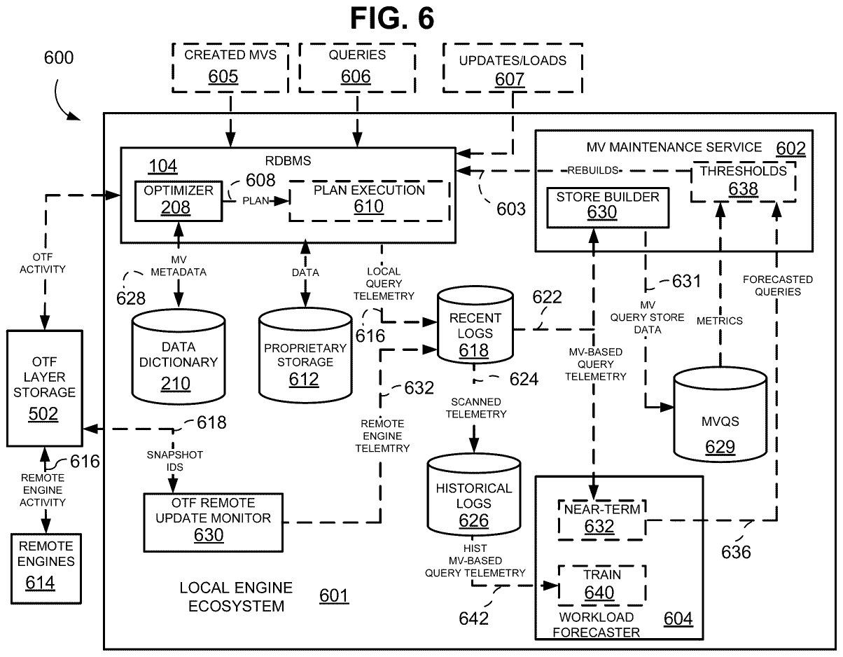

In one example, the RDBMS 104 may implement materialized views (“MVs”) created on base tables maintained in Open Table Format (“OTF”) storage. FIG. 5 is a block diagram of an example OTF storage layer operating with the RDBMS 104. In one example, an OTF catalog 500 may be maintained by the RDBMS 104, which includes metadata for each OTF table 501 and is further described with regard to FIG. 6. In one example, OTF layer storage 502 may be maintained separately from the RDBMS 104 and may be accessed by remote (foreign) systems (see FIG. 6) that also use the data stored in the OTF layer storage 502. Within the OTF layer storage 502, metadata files 504 may hold information regarding how OTF tables are used. In one example, a signature 506 (individually denoted as S1 through Sn) may be generated each time an OTF table 501 is used, such as signature information 5085 through plan execution 510. The signatures 506 may provide identifiers for an OTF table 501 and are generated after each OTF table 501 is updated. Even regarding remote systems, signatures 506 may indicate to the RDBMS 104 that an OTF table 501 has been updated.

In one example, “just-in-time” MV rebuilds may be performed on stale MVs whose frequencies and timings are limited to when most needed, namely when queries are forecasted for the near-term whose performance would significantly benefit or are needed to achieve SLGs. The feasibility to accurately forecast workloads may be based on the observation that queries and updates within enterprise workloads, especially those in production mode, are highly recurrent and often differ only by parameter values (literals). In addition, recurring requests are highly predictable with respect to their submission sequence. Such characteristics make it possible to forecast near-term database requests and proactively optimize MV maintenance for them. Furthermore, another observation is that many production workloads involving shared OTF data also share these same characteristics. Predictable behavior is required by most business applications, regardless of the underlying storage technology, and although applications with more random behavior exist, they are not typically the target of MV tuning.

In one example, the query logging mechanism of a database engine may be leveraged to capture telemetry related to MV usage and maintenance and extends it to include generic update events made on OTF data by external (foreign) engines. In turn, this telemetry is used to build a materialized view query store (“MVQS”) (see FIG. 6) that maintains historical summary query usage metrics for each MV owned by a database engine. Moreover, workload forecasting techniques may be leveraged to train a machine learning (“ML”) model that predicts queries for the near-term with the goal of proactively rebuilding a selected portion of MVs in advance of their execution. Unlike prior workload forecasting models that were limited to predicting resource usage or query arrival rates, this forecasting model may predict actual query statements and their sequence. After forecasting queries, threshold formulas may be applied to decide which individual MVs to proactively initiate rebuilds on in advance of the predicted queries.

FIG. 6 is an example of a service framework 600 that may be used to update MVs based on tables maintained in OTF layer storage 502. As discussed later in detail, the service framework 600 may rebuild MVs based on query telemetry associated with relevant MVs from both local and remote OTF data accessing. A local engine ecosystem 601 may handle remote OTF data activity to be used along with local activity by the RDBMS 104 in order to rebuild MVs. Workload forecasting may also be used to provide information used in MV rebuilds. In one example, an MV maintenance service 602 may perform the MV rebuilds 603, which are subsequently used by the RDBMS 104. The service framework 600 may also include a workload forecaster 604 responsible for providing workload forecasts allowing the MV maintenance service 602 to rebuild the MVs.

In one example, during operation, the RDBMS 104 may receive and/or create MVs 605 based on input from a client device 110. The MVs 605 may be used by queries 606 received by the RDBMS 104 via a client device 110. The RDBMS 104 may be responsible for data used for updates/loading 607. The RDBMS 104 may implement the optimizer 208 to generate query plans 608, which undergo execution 610. The RDBMS 104 may execute queries 606 on data residing in proprietary storage 612 or data stored in OTF layer storage 512. While the RDBMS 104 has full knowledge of how data is handled in the proprietary storage 612, the RDBMS 104 does not typically know all details of OTF layer storage data handling since it may be accessed by remote (foreign) engines (and/or tools) 614 that are proprietary to other entities.

Using database logging capabilities, the RDBMS 104 may log local query telemetry 616 that includes a variety of query and execution plan related telemetry. A log of recently-executed queries, recent logs 618, may be maintained. The recent logs 618 may also receive remote engine telemetry 620 as well. The MV maintenance service 602 may scan the recent logs 618 to identify any MV-based query telemetry 622, which may be used by both the MV maintenance service 602 and the workload forecaster 604. Once the recent logs 618 are scanned, scanned telemetry 624 may be sent to historical logs 626, which maintains all historical query telemetry. This includes local query telemetry 616 and may include remote engine telemetry 620.

With regard to logging OTF activity by remote engines 614, the local engine ecosystem 601 may implement an OTF remote update monitor module 630 which may log update operations made by external (foreign) engines or tools 614 on shared OTF tables. Detailed information is not required, but rather, it is sufficient to capture the approximate time update operations occur and the name of the target table. The magnitude of a given remote update operation (e.g., 1 row vs. 1 million rows) is not relevant to the MV rebuilds as MV staleness is a binary state and is not measured in levels or degrees. To detect remote updates, the OTF remote update monitor module 630 may periodically monitor the latest signatures 506 stored within the OTF layer storage 502 and compare them to the current snapshot IDs listed in the data dictionary 210. Note that this monitoring does not replace the previously mentioned staleness detection that occurs during query processing to avoid wrong results. When the OTF remote update monitor module 630 detects a new snapshot 506, remote engine telemetry 632 that may include a generic remote event along with the name of the target OTF table may be added to the recent logs 618, which in turn assists the workload forecaster 604 to predict future remote updates.

The MV maintenance service 602 may provide a “what-if” mode for the optimizer 208. When enabled, its cost-based plan selection logic remembers not only the best plan encountered thus far and its cost, but also the cost of the next best candidate plan that didn't involve MVs 604. Thus, the query logging subsystem may be used to populate Boolean flags that label logged requests whose execution plans involve MV usage or update operations that negatively impact (spoil) one or more persisted MVs 604. This allows the MV maintenance service 602 to apply filters when reading lengthy query logs maintained in recent logs 618. Table 1 below provides a non-exhaustive list of telemetry types, both local and remote, that may be captured by the MV maintenance service 602.

TABLE 1

| Local Engine Telemetry | Description or Purpose |
|---|---|
| SQL text of request | Input to workload forecaster |
| Parameter values (if any) | Input to workload forecaster |
| Submission timestamp | Input to workload forecaster |
| Optimizer's chosen Plan | Identify MV usage |
| Plan cost | Estimated cost of final chosen plan |
| Plan cost without MVs | Estimate cost of next best candidate |
| | plan with no MVs |
| Elapsed time and SLG | Actual latency relative to SLG |
| | assigned by WLM |
| MV usage flag, | True when logged request involves |
| OTF update flag | MV usage or spoil |
| MV IDs used in plan | IDs of MVs used in Plan |

| Foreign Engine Telemetry | Purpose in Maintaining MVs |
|---|---|
| Remote event type | Values: “update”, “other” |
| Remote event timestamp | Approx time of remote event |
| Remote OTF table name | Name of target table involved |
| | in the event |

In one example, the data dictionary 210 may maintain MV metadata 628 for MVs along with the OTF catalog 500. With each created MV 605, its specified definition may be stored along with:
(a) the system assigned internal identifier for the MV(MV_{id});
(b) the timestamp of the MV creation and latest rebuild;
(c) the cost of the creation and most recent rebuild;
(d) list of base table identifiers referenced in its definition; and
(e) staleness flag set to false after creation or rebuild and set to true if follow-on query processing detects new OTF snapshots.

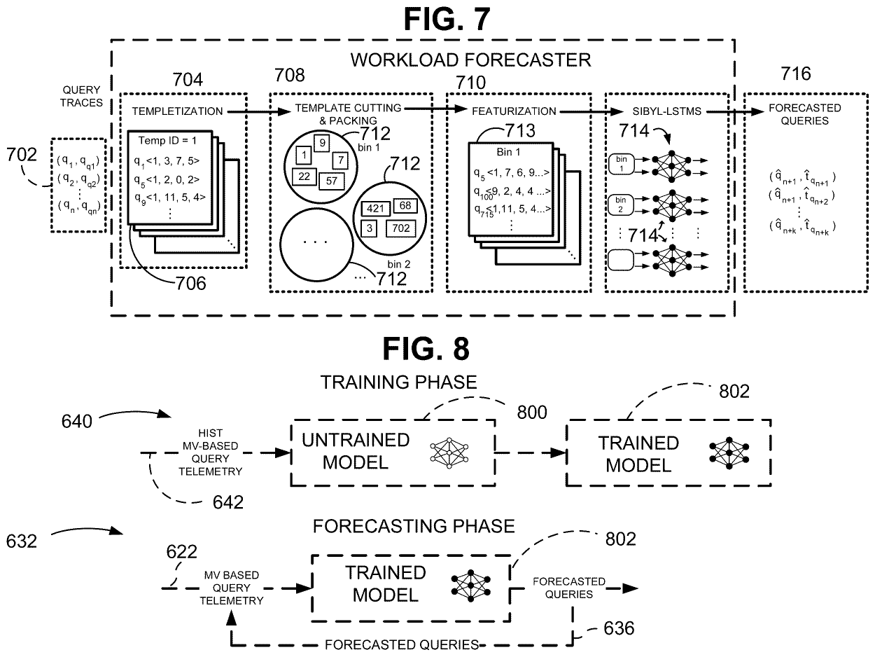

In one example, the MV metadata 628 stored in the data dictionary 210 may be supplemented by a materialized view query store (MVQS) 629. A store builder 630 used by the MV maintenance service 602 may summarize the usage of individual MVs 605 by groups of similar queries known as “templates” (see FIG. 7) with that summarized information being stored in the MVQS 629 with MV query store data 631. All query instances with the same abstract syntax tree (AST) are grouped into the same template. In one example, ASTs are the chosen method for defining templates to be consistent with the method of the workload forecaster 604 for grouping similar query instances.

Table 2 below provides that the MVQS 629 has one entry for each distinct combination of MV 604 and query template whose logged instances used that MV 607 in their optimizer chosen execution plan. A store key is denoted as MV_{id},AST_{q} where each AST is stored in JSON, XML, or any other structured representation that supports comparison for equivalence. Each MVQS 629 entry may calculate the average per-query cost savings gained from using MV_{id}, which is also the performance degradation it would suffer without it.

TABLE 2

| Query Store Field | Description & Purpose |
|---|---|
| Key: (MV_{id}, AST_{q}) | Dictionary ID of MV + |
| | AST of Query Template |
| Template Identifier | Forecaster assigned numeric ID |
| (alternate key for AST) | for AST_{q} (if known) |
| Total Query Cost Savings | Aggregate cost savings from |
| | queries using MV_{id} |
| Total Instances | # queries using MV_{id} |
| Avg per-instance Savings | Total Savings/Total Instances |
| Instances Requiring MV_{id} | # instances that may fail to meet |
| to meet SLG | SLG if MV_{id} is stale |

Metrics within the MVQS 629 are periodically updated by the MV maintenance service 602 prior to forecasting by incorporating any MV-based query telemetry 622 found within the recent logs 618 recent query log history (since it was last read). Logged query instances with MV Usage flag set to true have their AST generated by parsing the logged SQL text and along with the recorded MV IDs used in the plan are used to perform a store key lookup. If found, the existing entry is updated to incorporate the usage metrics. Otherwise, a new store entry is created. Lastly, each MVQS entry maintains a metric indicating the number of query instances that likely would not have met their SLG without the MV 605. It is incremented for each logged query using the following algorithm written in pseudo-code similar to the ‘C’ programming language and that operates on variables populated from query log telemetry:

### If (MV Usage && Elapsed Time<=SLG)

Percent Increase=((Plan Cost without MV)−(Plan Cost with MV))/(Plan Cost without MV);

Latency Increase=Percent Increase*Elapsed Time;

### If (Elapsed Time+Latency Increase)>SLG InstancesRequringSLG++;

The workload forecaster 602 includes near-term query generation 632 which may be responsible for providing forecasted queries 636 to threshold determination 638 of the MV maintenance service. The workload forecaster 604 also undergoes training 640 based on the historical MV-based telemetry 642 stored in the historical logs 626. The workload forecaster 602 may employ a machine learning framework, such as the SIBYL forecaster, for example, capable of forecasting a sequence of queries for a caller-specified time interval. As shown in FIG. 7, the workload forecaster 604 may organize an input workload 702 (query traces) into groups of similar queries (templatization 704) into templates 706. The templates 706 undergo template cutting and packing 708 then featurization 710. Forecasting is done using a Long Short-Term Memory Network (LSTM) model that is ideally suited for predicting time series events. The use of templates 706 assumes that enterprise workloads typically consist of many queries that differ only by their parameter values. Separate LSTM models 714 are maintained for each template and when supporting a high number of templates they are first packed into “bins” 712 to limit the number of LSTMs to one per bin. The featurized bins 713 may then be input into the separate LSTM models 714 to generate the forecasted queries 716.

FIG. 8 is an example of the workload forecaster training 640 and the near-term forecasting generation 632. With regard to the training 640, the workload forecaster 603 may begin as untrained model 800. The historical MV-based query telemetry 642 may be used to generate trained model 802. The workload forecaster 603 may be trained once with the historical MV-based query telemetry 640 and then used to generate forecasted queries 716. The trained model 802 may be “fine-tuned” using the forecasted queries 716. After that, the forecasting phase is periodically invoked by the MV maintenance service 602 passing it the logged queries that have taken place since the last invocation. Telemetry input for the training and forecasting phases may consist of SQL text, parameter values, and query arrival times taken from query traces (logs), for example. Applying a filter on the previously mentioned MV Usage and OTF Update flags significantly reduces the size of the workload forecaster 604 input and ensures the set of templates 706 generated and used in the LSTMs are focused on workload streams that are most relevant to the task at hand.

The workload forecaster 604 assigns a unique numeric ID to each template 706 to serve as a substitute for the AST during binning and featurization. For those templates 706 with enough instances to warrant their own bin, a dedicated LSTM is used to forecast future queries. In such cases, the predicted queries output by the LSTM can be labeled with their Template ID, which if made known to the MVQS 629 will support fast store key lookups without having to generate ASTs from parsing the SQL text of forecasted queries.

To facilitate this fast lookup, the forecasting may be extended to support an API that when passed an AST returns the assigned Template ID. This API is called by the MV maintenance service 602 when creating new entries in the MVQS 629 or when updating existing entries with uninitialized Template IDs. If forecasted queries do not have a Template ID (e.g., their template was binned with others) or if the MVQS 629 is not yet aware of it, the forecasted SQL text can be parsed to generate the AST for store key lookup.

After updating the MVQS 629 with the latest historical query log telemetry and invoking the workload forecaster 603 to predict the near-term upcoming workload, the MV maintenance service 602 may perform threshold determination 638. In one example, the following threshold for each individual MV 605 marked stale in the data dictionary 210 may be determined, and when true, an immediate rebuild is scheduled. Metrics 648 referenced in the threshold algorithm below are read from the MVQS 629:
PainFactor=10; damage from missing an SLG
If(Instances requiring MV for SLG>=0.25*Total Instances)
   RequriredForSLG=true;
Else RequiredForSLG=false;
Total Workload Savings for queries 1 to n using Mvid

$${\sum }_{q = 1}^{n} ( MVid , ASTq ) \cdot AvgSavings * ( RequiredForSLG ? PainFactor : 1 )$$

If Total Workload Savings>=Rebuild Cost for Mvid
   ThresholdMet=true;
Else ThresholdMet=false;
The threshold determination 638 compares the cost to rebuild a given MV 605 against the cost savings that forecasted queries 716 will gain from their availability. “Rebuild cost” is based on the actual cost of the latest rebuild (or initial creation) as recorded in the data dictionary 210. “Workload Savings” is calculated by aggregating the MV cost savings for each predicted query by using the average savings recorded for its template 706 within the MVQS 629. A weighted “pain factor” is applied to increase the savings if past instances in the template often require the MV to achieve their SLG. The pain factor may be adjusted according to desired performance.

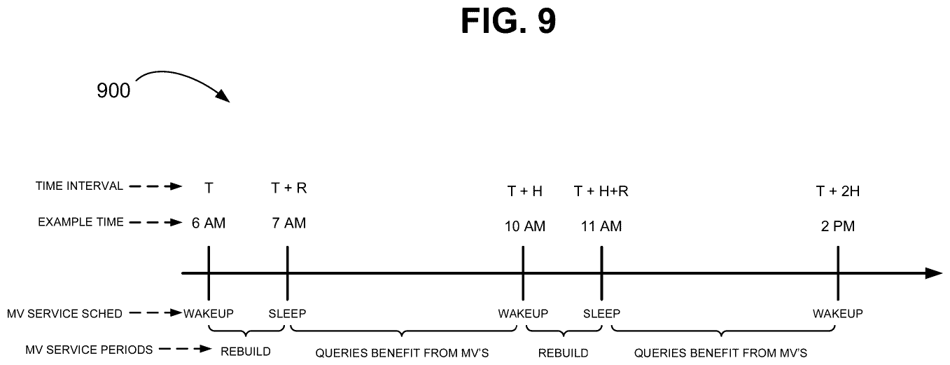

As described, during operation, the MV maintenance service 602 conducts the following operations: (1) Scan query log for recently completed queries involving MVs and incorporate usage into the query store (MVQS); (2) Input recently logged queries to the workload forecaster 605 and forecast near-term future queries; (3) Apply thresholds to decide which MVs 605 to rebuild to benefit forecasted queries that are similar to those in the store; and (4) Initiate rebuilds for chosen MVs 605 using one or more parallel sessions with the RDBMS 104 to complete within a time period of R. These tasks are ideally completed in advance of any predicted queries that would benefit from rebuilt MVs 603. As illustrated in the timeline 900 shown in FIG. 9, the MV maintenance service 602 is configured to wake up every H hours (default=4) with the intent of rebuilding MVs in advance of forecasted queries occurring over the next H hours, while allowing for an initial R minutes (default=60) of that period to complete rebuilds.

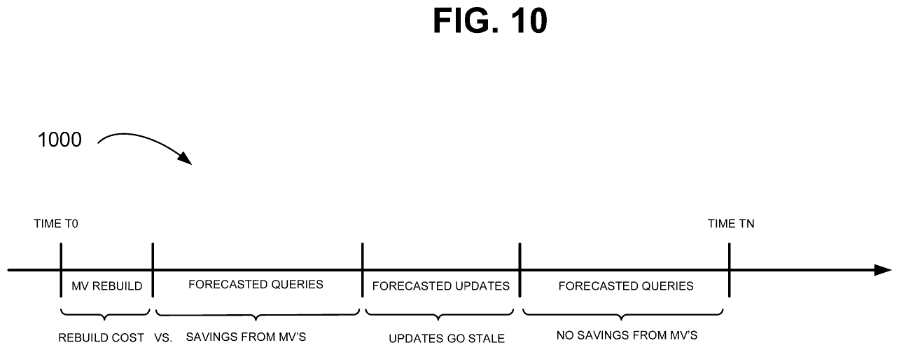

However, the prior threshold algorithm provided assumes the predicted workload does not include updates to OTF data, that would result in MVs 605 used by predicted queries to go stale once again during the forecasted period. The specific MVs 605 impacted by a predicted update may be determined by comparing the target table name of the update operation with the list of base tables for each MV 605 defined in the data dictionary 210. Given that the present disclosure is based on rebuilding MVs 605 in advance of predicted workloads, the presence of predicted updates interleaved with queries is challenging and requires consideration of the sequence order of predicted requests. FIG. 10 is an example of an extension 1000 to the threshold algorithm described above to consider the savings of only those queries that occur prior to the first predicted update in the overall sequence. If their benefit alone is greater than the rebuild cost, then the proactive rebuild is still beneficial.

Attempting to schedule or trigger MV rebuilds for a future time period is generally not feasible or cost effective. The time required for rebuilding stale MVs can be long making them unavailable for use by queries for significant portions of the remaining forecasted period. In addition, a predicted update “operation” may consist of a series of discrete engine operations making it difficult to know when the last one has finished and the rebuild can begin. Hence, our solution does not proactively rebuild MVs when the forecasted period contains numerous updates scattered throughout it.

Table 3 lists representative workload types, each with different read/write patterns and remote (foreign) engine involvement. The present disclosure works well for traditional Enterprise Data Warehouse (EDW) patterns consisting of sustained periods of read-only activity including “query by day, update at night”. The present disclosure also extends to EDW workloads that transition to OTF environments where multiple engines (possibly heterogenous) are reading and writing shared data, but each engine continues to run EDW-like workloads. After coalescing the write patterns of all participating engines, it is still possible to find sustained periods of read-only activity that would benefit from MVs with no imminent danger of going stale. The last workload type listed in Table 3 represents patterns containing updates that are continually interleaved with updates. That pattern is not suitable for the present disclosure given the excessive costs that would result from rebuilding and the negative return-on-investment as compared with the benefit to queries.

TABLE 3

| | Read/Write | MV |
|---|---|---|
| Workload | Patterns | Maintenance |
| EDW with portions | Long periods of read- | Selected rebuilds |
| of data in OTF | only interleaved with | just prior to |
| | periods of write-only. | read-only periods. |
| | Foreign engines mainly | |
| | read-only. | |
| Multiple Engines | Individual engines have | Like EDW after |
| with joint | similar EDW read-write | assembling write |
| ownership of | patterns but not | patterns of all |
| OTF data | synced with each other. | engines. |
| Continuous trickle | No read-only periods - | N/A - not suitable |
| updates on OTF | writes continually | for MVs |
| data | interleaved with reads | |

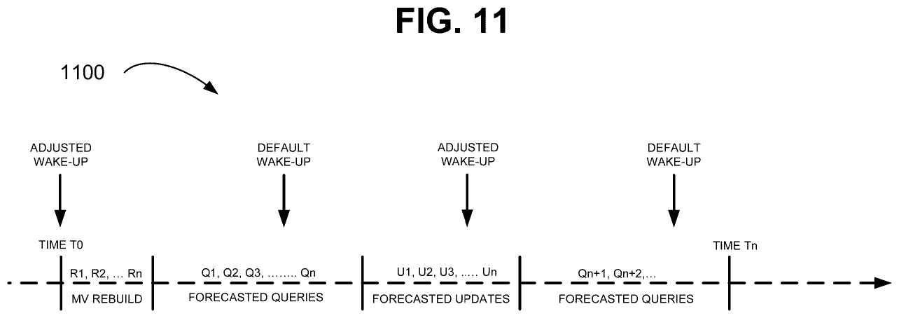

As illustrated in FIG. 9 the initial schedule for the MV maintenance service wakes up every H hours with the intent of rebuilding MVs in advance of forecasted queries occurring over the next H hours. Ideally, the service wakes up and does its forecasting prior to a sustained period of read-only queries and begins performing its recommended rebuilds at a well-known point in time, namely after the completion of forecasting and threshold calculations and continuing through the designated rebuild period (R minutes). If the service wakes up towards the end of read-only period periods, the scheduling of rebuilds is complicated. FIG. 11 shows an example of adjusted timeline 1100 in which this challenge may be overcome by adjusting service wake-up times to align with observed workload patterns.

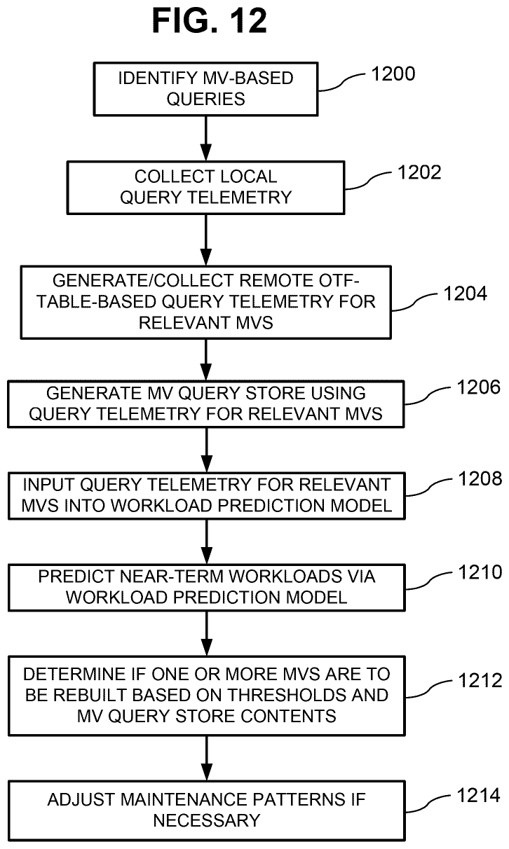

FIG. 12 is an example operational flow diagram of the local engine ecosystem 601. In one example, MV-based queries on OFT tables 501 may be identified by the RDBMS 104 (1200). Locally generated query telemetry may be collected (1202), such as in recent logs. MV-related telemetry regarding queried OTF tables 501 relating to remote engine 614 activity may be generated by the OTF remote update monitor 630 and collected in recent logs 618 (1204). The MV maintenance service 602 may create the MV query store 629 (1206) based on relevant MV-based query telemetry 622. Historical MV-based query telemetry 642 may be provided to the workload forecaster 604 in order generate forecasted queries to be provided to the MV maintenance service 602 (1208). The near-term workloads may be predicted by the workload forecaster 604 (1210). The MV maintenance service may determine if one or more MVs are to be rebuilt based on the determined thresholds and contents of the MV query store 629 (1212). The maintenance patterns may be adjusted, if necessary (1214).

While various embodiments of the disclosure have been described, it will be apparent to those of ordinary skill in the art that many more embodiments and implementations are possible within the scope of the disclosure. Accordingly, the disclosure is not to be restricted except in light of the attached claims and their equivalents.

I claim:

1. A system comprising:
a storage device;
a plurality of processors in communication with the storage device, wherein at least one of the plurality of processors is configured to:
collect query telemetry associated with queries executed on data stored in Open Table Format storage;
predict at least one query to be received based on at least a portion of the collected query telemetry;
identify a materialized view (“MV”) in the collected query telemetry associated with the at least one predicted query;
determine if the identified MV is to be rebuilt based on at least one condition;
in response to presence of the at least one condition, rebuild the MV to be used during execution of the predicted query; and
execute the predicted query upon receipt of the predicted query.

2. The system of claim 1, wherein the collected query telemetry is associated with a local database management system.

2. The system of claim 1, wherein the collected query telemetry is associated with a remote system.

4. The system of claim 3, wherein the at least one of the processing nodes is configured to generate the collected telemetry associated with the remote system based on identified actions of the remote system.

5. The system of claim 1, wherein the plurality of processors is further configured to:
generate a materialized view query store comprising metrics associated with the identified materialized view.

6. The system of claim 1, wherein the at least one condition is a cost of rebuilding the identified MV.

7. The system of claim 1, wherein scheduling of rebuilding of the identified MV is based on identified workload patterns associated with the identified MV.

8. A method comprising:
collecting, with a processor, query telemetry associated with queries executed on data stored in Open Table Format storage;
predicting, with the processor, at least one query to be received based on at least a portion of the collected query telemetry;
identifying, with the processor, a materialized view (“MV”) in the collected query telemetry associated with the at least one predicted query;
determining, with the processor, if the identified MV is to be rebuilt based on at least one condition;
in response to presence of the at least one condition, rebuilding, with the processor, the MV to be used during execution of the predicted query; and
executing, with the processor, the predicted query upon receipt of the predicted query.

9. The method of claim 8, wherein the collected query telemetry is associated with a local database management system.

10. The method of claim 8, wherein the collected query telemetry is associated with a remote system.

11. The method of claim 10 further comprising generating, with the processor, the collected telemetry associated with the remote system based on identified actions of the remote system.

12. The method of claim 8 further comprising generating, with the processor, a materialized view query store comprising metrics associated with the identified materialized view.

13. The method of claim 8, wherein the at least one condition is a cost of rebuilding the identified MV.

14. The method of claim 8, wherein scheduling of rebuilding of the identified MV is based on identified workload patterns associated with the identified MV.

15. A non-transitory computer-readable medium encoded with a plurality of instructions executable by a processor, the plurality of instructions comprising:
instructions to collect query telemetry associated with queries executed on data stored in Open Table Format storage;
instructions to predict at least one query to be received based on at least a portion of the collected query telemetry;
instructions to identify a materialized view (“MV”) in the collected query telemetry associated with the at least one predicted query;
instructions to determine if the identified MV is to be rebuilt based on at least one condition;
in response to presence of the at least one condition, instructions to rebuild the MV to be used during execution of the predicted query; and
executing, with the processor, the predicted query upon receipt of the predicted query.

16. The non-transitory medium of claim 15, wherein the collected query telemetry is associated with a local database management system.

17. The non-transitory medium of claim 15, wherein the collected query telemetry is associated with a remote system.

18. The non-transitory medium of claim 17, wherein the plurality of instructions further comprises instructions to generate the collected telemetry associated with the remote system based on identified actions of the remote system.

19. The non-transitory medium of claim 15, wherein the plurality of instructions further comprises generating, with the processor, a materialized view query store comprising metrics associated with the identified materialized view.

20. The non-transitory medium of claim 15, wherein the at least one condition is a cost of rebuilding the identified MV.
